(19) United States
(12) Patent Application Publication
(10) Pub. No.: US 2024/0417626 A1
(43) Pub. Date: Dec. 19, 2024

(54) Fuel Generation System and Process

(71) Applicant: Nordic Electrofuel AS, Baerum (NO)

(72) Inventors: Rune Løvstad, Bærum (NO); Erling Rytter, Bærum (NO); Bjørn Bringedal, Bærum (NO)

(21) Appl. No.: 18/705,741

(22) PCT Filed: Nov. 2, 2022
(86) PCT No.: PCT/EP2022/080525

§ 371 Date: Apr. 29, 2024

(30) Foreign Application Priority Data
Nov. 9, 2021 (GB) 2116072.6

(51) Int. Cl. C10G 2/00; C01B 3/36; C25B 1/04

(52) U.S. Cl. CPC C10G 2/50; C01B 3/36; C10G 2/30; C25B 1/04; C01B 2203/062

(57) ABSTRACT

Disclosed herein is a fuel generation system comprising: a Fischer-Tropsch (FT) reactor system; and one or more supply conduits arranged to supply a carbon source and H₂ to the FT reactor system; wherein: the carbon source comprises both CO and CO₂ with a molar CO₂/CO ratio that is at least 0.10; the supply of CO and H₂ to the FT reactor system is a supply of syngas; and the FT reactor system is arranged to generate fuel in dependence on the received syngas.

### FIELD

The present invention relates to the production of hydrocarbons. Embodiments include producing hydrocarbons from a carbon source that comprises both carbon dioxide and carbon monoxide. Embodiments include adding hydrogen to the carbon source and producing hydrocarbons by the Fischer-Tropsch process.

### BACKGROUND

It is commonly assumed that the greenhouse effect and the climate on earth are closely connected to human made emissions of CO₂. These emissions are primarily formed by combustion of fossil coal and hydrocarbons, i.e., by generation of heat, electric power as well as use in internal combustion engines in vehicles. A desirable goal is to reduce the emission of CO₂ to the atmosphere.

It is known art to reduce the emission of CO₂ from combustion of hydrocarbons by reforming and shift technology for preparation of a mixture consisting of hydrogen and carbon dioxide. These components can be separated, where after hydrogen is used for energy generation, heat or in different types of transportation, and carbon dioxide is deposited after compression to desired pressure. However, no such technology is operated today, at least in any appreciable amount.

An alternative technology is to utilize hydrogen and CO to produce fuels, waxes and other hydrocarbons for today's market, particularly diesel for transportation vehicles and waxes for a multitude of applications, including glues.

There is a general need to improve on known techniques for the production of hydrocarbons.

### SUMMARY

Aspects of the invention are set out in the appended independent claims. Optional aspects are set out in the dependent claims.

### LIST OF FIGURES

FIG. 1 is a schematic block diagram of at least some of the components of a fuel generation system according to an embodiment;

FIG. 2 comprises a table that shows different compositions (mol %) of carbon sources;

FIG. 3 shows the molar fraction of the feed to a FT reactor and CO₂/CO ratio in a system according to an embodiment;

FIG. 4 shows the molar fractions in dried tail-gas in a system according to an embodiment;

FIG. 5 is a schematic block diagram of at least some of the components of a fuel generation system according to an embodiment; and

FIG. 6 is a schematic block diagram of at least some of the components of a fuel generation system according to an embodiment.

### DESCRIPTION

Embodiments relate to techniques for generating fuels from a carbon source, that comprises both carbon monoxide (CO) and carbon dioxide (CO₂), together with on purpose generated hydrogen. Such a carbon source may be the off-gas from the production of iron or ferroalloys. The carbon source may alternatively be gas obtained from the gasification of biomass, or gas generated by the reforming of natural gas at a temperature below what is standard practice.

Embodiments provide a fuel generation system that produces synthetic hydrocarbons for replacing fossil fuels. The produced synthetic fuels may include kerosene (jet-fuel), diesel, and gasoline. The synthetic hydrocarbons can be produced from synthesis gas, i.e. syngas, that is a mixture of hydrogen (H₂) and carbon monoxide (CO).

It is known to generate the CO component of syngas by using the reverse (d) water gas shift reaction (rWGS/RWGS), in which the main Carbon supply to the system is CO₂. The CO₂ is converted to CO in a rWGS reactor. The generated CO may then be mixed with hydrogen to generate syngas that may be fed into a Fischer-Tropsch reactor. However, a suitable rWGS reactor is not yet commercially available due to many challenging technical problems.

Embodiments advantageously generate syngas without first requiring a rWGS reactor for converting the main Carbon supply to the system to CO. The system according to embodiments may use a combination of a Fischer-Tropsch reactor, that is arranged to operate with a very high fraction of inerts (CO₂ and N₂), and a CO generation system, that may comprise a conventional POX reactor, and is arranged to convert the off-gas from the Fischer-Tropsch reactor CO.

In embodiments, the fraction of inerts (i.e. gasses that do not substantially react) in the Fischer-Tropsch reactor and/or CO generation system may typically be 60% and may be as high as 80%. This allows utilization of a very wide range of carbon sources. In particular, the process can receive the blast furnaces gas from ferromanganese and ferrosilicon production pants.

The fuel generation system according to embodiments comprises a Fischer-Tropsch (FT) reactor. The feed to the FT reactor comprises syngas (synthesis gas). For an FT-reactor containing a cobalt catalyst, the reactive components are H₂ and CO, preferably in an H₂/CO ratio larger than 1 and below 2.5. In addition, inert components may be present in the feed to the FT reactor in addition to syngas. These may comprise methane, CO₂, nitrogen and water. Inert components are generally considered to be unfavorable as they contribute to larger than necessary process units; in particular because most FT schemes contain recycle stream(s) to secure high overall conversion of the carbon containing feed to desired hydrocarbon products. Thus, recycle results in build-up of the inert components.

Water may be removed by condensing it at adequate places in the process, whereas nitrogen needs to be removed from the system through a purge gas. Therefore, there is an upper threshold of the concentration of nitrogen (and other inert gases like noble gases) in the feed gas to have a suitable process.

As to the carbon source for making CO in the syngas, this is most commonly natural gas, essentially methane, or coal, but can also be various biomasses. They are converted in reformers or gasifiers to make syngas. Apart from being inert in the FT-reaction, methane is in fact a byproduct of the reaction; typically, with a carbon selectivity between 5 and 15%. In addition comes a minor amount of methane not converted in the reformer; called methane slip. It follows that there is a way to remove methane in the process by having a reformer. This can be the reformer used to convert natural gas, or a dedicated reformer used to reform a part of the recycle gas; a tail-gas reformer. The recycle gas, i.e. the tail-gas, from the FT-reactor further contains other inerts, unconverted syngas and some light hydrocarbons that have not been condensed as part of the product. Part of the tail-gas is purged and/or used in a fired-heater for heating feed streams to maximize energy efficiency.

Like methane, CO₂ is also an inert in the FT-reaction, but can as well constitute a carbon source. If fed to a reformer, the process is called a dry-reforming process; a process that requires large amounts of added energy. CO₂ can also be converted to CO through the reverse-gas-shift-reaction; RWGS:

CO₂+H₂→CO+H₂O

that proceeds at elevated temperatures with addition of hydrogen; the higher temperature the larger the conversion. With CO₂ as the only, or an important part of, the feed, hydrogen may be added from another source to secure that the H₂/CO ratio is adequate. Such a hydrogen source can be steam-reforming of natural gas, or electrolysis of water.

Processes are being developed that use CO₂ as feed together with hydrogen from electrolysis. Frequently they contain a tail-gas reformer and a RWGS reactor; at least a RWGS section. The inventors have discovered that the FT-process can be simplified if a carbon source can be found that from the outset contains both CO and CO₂. Indeed, a suitable such source is the off-gas from blast-furnaces, e.g., when iron ore is reduced with coke in a blast-furnace. Blast-furnaces are also employed for production of ferroalloys like ferromanganese and ferrosilicon. Other techniques comprise electric arc furnaces and direct carbothermic reactions.

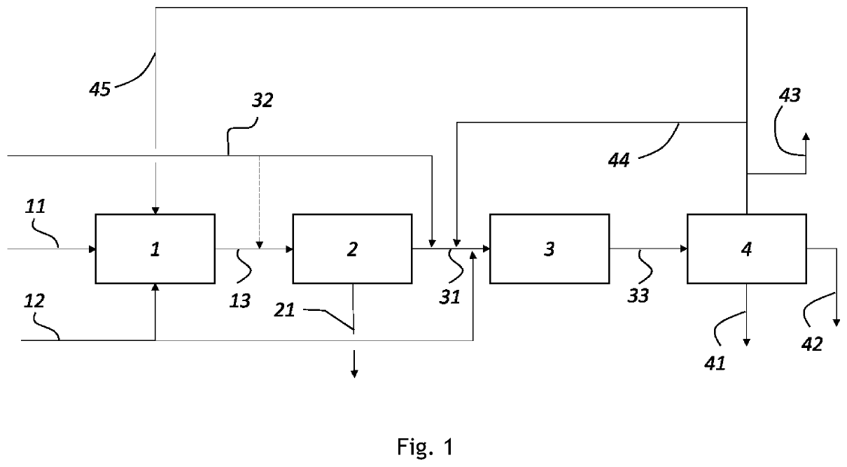

FIG. 1 is a schematic block diagram of at least some of the components of a fuel generation system according to an embodiment. The components of the system may include a CO generation system 1, a cleaning section 2, a Fischer-Tropsch (FT) reactor 3 and a separation system 4.

Stream 32 is an input supply conduit. The fluid in stream 32 is a supply of carbon, i.e. a carbon source, to the system according to an embodiment. The fluid in stream 32 may comprise both CO₂ and CO. Stream 32 may bypass the CO generation system 1 and be an input to the FT reactor 3. Depending on the purity and water content of the carbon source, stream 32 may alternatively, or additionally, be input into the cleaning section 2.

The carbon source may be of specified purity and may have been purified by additional means not shown in FIG. 1, e.g., to remove traces of sulfur. The carbon source may also comprise an amount of nitrogen, that may be a significant amount of nitrogen, that may be purged through output stream 43.

The CO generation system 1 may be a system that comprises a single reactor or plurality of reactors. The CO generation system 1 may comprise a partial oxidation (POX) reactor and or a reformer.

Hydrogen may be fed to the CO generation system 1 and FT reactor 3 through line 12 that is a fluid supply conduit. The amount of hydrogen supplied to the CO generation system 1 may be smaller than the amount of hydrogen fed directly to the FT reactor 3. The hydrogen in line 12 can come from any viable source, e.g., produced by electrolysis of water. The process units 1, 2, 3, and 4 may be operated at elevated pressures typically between 10 and 60 bar, and preferably in the range 25-40 bar. Accordingly, both of the feed streams of hydrogen and the carbon source, in the respective conduits line 12 and stream 32, may be pressurized to operating pressure before entering the system. The process units 1, 2, 3 and 4 may be operated at the same, or different, pressures.

Stream 11 is a fluid conduit that may comprise a supply of oxygen into the system. The CO generation system 1 may be fed by oxygen through stream 11, hydrogen through stream 12, and a recycling stream 45 of a portion of the tail gas (described in more detail later). The system may comprise an output conduit of the CO generation system 1. The output conduit may comprise a fluid stream 13. The fluid stream 13 may comprise reformed gas generated in the CO generation system 1. The fluid stream 13 may comprise a substantial amount of syngas (i.e. CO and hydrogen), in addition to steam, unconverted CO₂, residual methane and possibly nitrogen that was comprised by the carbon rich feed stream 32. The CO generation system 1 may only generate CO in dependence on the carbon from the tail gas. The amount of carbon fed to the CO generation system 1 may be substantially less than the amount of carbon in the carbon source, i.e. in stream 32.

Before entering the Fischer-Tropsch reactor 3, the syngas in fluid stream 13 may be cooled down by a cooler (that is not shown in FIG. 1) and be fed into the cleaning section 2 for cleaning and/or adjustments. In particular, in the cleaning section 2, water may be knocked out of the fluid stream 13 and leave the system in an output conduit that supports the fluid stream 21. The syngas may also be cleaned to remove impurities, in particular because a Co-based FT-catalyst may be highly sensitive to certain impurities. The cleaning section 2 has a main output conduit that is arranged to supply at least syngas to fluid stream 31. Syngas for FT-synthesis in the FT reactor 3 enters the FT reactor 3 through fluid stream 31. Fluid stream 31 may also comprise recycled unconverted gas in fluid stream 44 and hydrogen that is supplied by fluid stream 12.

The recycled gas in fluid stream 44 is part of the tail gas and may comprise, in addition to unconverted syngas, part of produced light gases comprising mostly methane, but also CO₂, light hydrocarbons, oxygenates and a variable amount of nitrogen.

The FT reactor has an output conduit that supports fluid stream 33. Fluid stream 33 comprises FT-products that are generated in the FT reactor 3. Fluid stream 33 may also comprise unconverted syngas. Fluid stream 33 may comprise two sub-streams, a gaseous stream and a liquid stream. Although only one FT reactor 3 is shown in FIG. 1, embodiments also include the use of a FT reactor system with a single FT reactor 3, or a plurality of FT reactors 3 arranged in parallel and/or in series with each other. For example, there may be a series arrangement of FT reactors 3 with a hydrogen fed, and/or water removal process, between adjacent FT reactors 3.

Fluid stream 33 flows into the separation system 4. The separation system 4 shown in FIG. 1 is clearly simplified. Embodiments include performing any of the large number of known techniques for FT-product separation, treatment and upgrading on the fluid stream 33.

The separation system 4 may comprise separate systems for separate treatments of the gaseous and liquid components of fluid stream 33. The separation system 4 may comprise one or more output conduits for supporting liquid stream(s) 42. The liquid steam 42 may comprise liquid fuel that is the main intended product of the fuel generation system. The liquid stream(s) 42 may be output from the system and optionally undergo stabilization and light and/or deep upgrading, such as hydro-treatment. The liquid stream 42 is output from the system for storage and shipment.

The gaseous component of fluid stream 33 may be cooled down in a three-phase separator. The lower part contains produced water by the FT-reaction and this may be output from the system in a conduit that supports fluid stream 41. Liquid hydrocarbons may also be obtained, that are lighter that the primary liquid output from the FT reactor 3, and may be stored and processed separately from the primary liquid from FT reactor 3 in stream 42.

The remaining gas output from the separation system 4 is referred to a tail gas and is supported in an output conduit of the separation system 4. The tail gas may comprise unconverted syngas, produced light hydrocarbons and CO₂. Embodiments may increase the carbon utilization efficiency by converting at least some of the CO₂ and the gaseous hydrocarbons in the tail gas to CO for use in the FT reactor 3. This conversion is performed in the CO generation system 1. Embodiments may also provide a high CO conversion in the FT-reactor loop within the system. Embodiments may also purge nitrogen and other inert components from the system.

Accordingly, the tail-gas may be split into three parts in separate fluid streams that are: a flow of purge gas 43, a syngas recycle 44 that is fed back to the FT reactor 3 in an inner recycle loop, and an outer recycle 45 that is fed back to the CO generation system 1.

Aspects of the above-described system according to an embodiment are described in more detail below.

As described above, hydrogen is supplied to the system through fluid stream 12. The hydrogen may have been produced in a multitude of known ways. One such way is electrolysis of water. Hydrogen in the transport sector as fuel for fuel cells is gaining increased attention, and fueling stations for transportation vehicles are being deployed in several areas of the world, notably in the USA, Europe and Japan. Practically all of these fueling stations are based on hydrogen made by splitting water through electrolysis and compressing hydrogen to typically 700 bar. Liquid hydrogen is being considered for heavier transport like ships and trains. Electric power for the electrolysis can come from renewable energy sources like wind power, hydroelectric power and photovoltaic solar cells. Other technologies like plasma splitting, direct catalytic water splitting, and high-temperature water splitting are being explored. It is also possible to obtain benign hydrogen from reforming of natural gas followed by depositions of CO₂ in a reservoir.

There are several types of electrolysis available, the most common being alkaline electrolysis. Other methods comprise polymer electrolyte membrane electrolysis, carbonate electrolyte electrolysis, and solid-oxide electrolysis. The alkaline electrolysis cell has two electrodes separated by a diaphragm and operated in an alkaline solution of potassium or sodium hydroxide. The diaphragm facilitates transportation of hydroxide ions from one electrode to the other, and helps separate the evolved hydrogen and oxygen gases. Embodiments do not rely on a specific method for producing hydrogen and embodiments include the hydrogen in the fluid stream 12 being supplied from any type of hydrogen source. However, hydrogen production methods with low carbon footprints are preferred.

Carbon dioxide is available in large amounts; in particular there is presently approximately 410 ppm in the global atmosphere, and this is steadily increasing. Adsorbents have been installed to capture CO₂ from the atmosphere for use in greenhouses on a small scale. Another source of CO₂ is from biomass; either through combustion or fermentation, or by photochemical or chemical processing. It has been assumed that such CO₂ does not contribute to the greenhouse effect and global warming. CO₂ is also readily available from several industrial processes; generally, from fired heaters or combustion turbines, but also as a main byproduct as in ammonia synthesis, hydrogen production, and cement manufacture. Large amounts of CO₂ evolve from deposits of municipal solid wastes, and from distributed heat systems. The main sources of man-made CO₂, however, is from utilizing gas, oil and coal in electricity production and in the transportation sector. Embodiments do not rely on a specific source of CO₂ and the CO₂ in the fluid stream 32 may be from any source of CO₂. However, a CO₂ source with a low overall carbon footprint is preferred.

The conversion of CO₂ and hydrogen to liquid hydrocarbons according to embodiments may be based on a 3-step procedure comprising: 1) producing synthesis gas (syngas) essentially comprising hydrogen and CO; 2) synthesis gas conversion by Fischer-Tropsch (FT) synthesis; and 3) upgrading of raw FT products (wax and naphtha/distillates) to final products such as naphtha, kerosene, diesel or other products, for example lube oil base. Wax is also in itself a valuable product. The upgrading typically uses hydrogen in hydrogenation, hydrocracking and/or isomerization processes. Such upgrading stabilizes the products; by converting olefins to alkanes, and removing produced oxygenates; adjusting chain lengths to the desired region; and isomerizing alkanes to improve cold properties of the products. The upgrading may take place wholly or in part at the production site, or the products can be transported to a dedicated refinery.

FT synthesis can be classified as a High-Temperature FT (HTFT) process operating at 330-370° C. and Low-Temperature FT (LTFT) at 210-260° C. The former gives products mainly in the naphtha range containing linear and branched olefins with high aromatics and oxygenate content. The HTFT process may be practiced based on precipitated iron catalysts with stability and selectivity promoters. Preferably, the system according to embodiments is of the LTFT type. In this process, typically, a cobalt based catalyst converts syngas mainly to linear long-chained paraffins and some lighter olefins, a mixture of methane, petroleum gases, naphtha, kerosene and wax. The liquid and solid products can be upgraded by hydro-treating and -cracking to a clean-burning diesel fuel. Another favorable product is jetfuel that for the most part is composed of naphtha and kerosene upgraded to specifications. Typical grades are Jet A, Jet A-1 and Jet B. The produced fuel may be virtually free of sulfur, aromatics and nitrogen compounds, and is excellent as a blending stock for conventional diesel. Supported cobalt catalysts may be the preferred catalysts for the FT synthesis. The most important properties of a cobalt FT catalyst are the activity, the selectivity, usually to C₅ and heavier products, and the resistance towards deactivation. Known catalysts are typically based on titania, silica or alumina supports, and various metals and metal oxides have been shown to be useful as promoters. The FT synthesis can be performed in several types of chemical reactors, the most common being fixed-bed tubular and slurry bubble column types. Other useful reactors comprise microchannel reactors; fluid-bed reactors; and reactors filled with internals like monoliths, sponges, or cassettes for direction of syngas flow and improved heat transfer. By varying the catalyst and process conditions, the products may be directed at alternative products slates, e.g., containing larger amounts of olefins and/or oxygenates that then constitute part of the sought product slate.

The LTFT process concerns hydro-polymerization of carbon monoxide

2nH₂+nCO→—(CH₂)ₙ—+ₙH₂O
to give linear alkanes by the overall reaction

(2n+1)H₂+nCO→CₙH₍₂ₙ₊₂₎+nH₂O ΔH −154 KJ/mol (α=0.95)
where n is the chain length of the carbon backbone. The most important side reactions are α-alkene formation by

2nH₂+nCO→CₙH₂ₙ+nH₂O
and a separate reaction pathway to methane:

3H₂+CO→CH₄+H₂O ΔH=−88 KJ/mol

On a schematic level, the feed molecules CO and H₂ may be activated on the surface of the FT metal, followed by hydrogenation of carbon and oxygen, chain growth by successively adding —CH₂— monomer units and termination. Alkanes can be formed by hydrogenation of the growing chain, whereas β-hydrogen abstraction leads to α-alkenes. Further hydrogenation of surface —CHₓ gives methane. For each carbon unit in the product there will be one water molecule formed. It is to be understood that the above is only a schematic description of the FT-mechanism, and several mechanistic pathways have been proposed in the literature. For example, it is possible that the primary products are olefins, and that alkanes are made by secondary hydrogenation.

A wide range of chain lengths are produced by FT-synthesis as determined by the value of chain termination probability relative to chain growth probability. In general, the product slate follows the Anderson-Schultz-Flory (SFA) distribution as expressed by:

$${W}_{n} / n = {( 1 - α )}^{2} {α}^{n - 1}$$

where Wₙ is the weight fraction of a chain with a given chain length n, and α defines the chain growth probability according to

$$α = {r}_{p} / ( {r}_{p} + {r}_{t} ) .$$

Here, rₚ and rₜ are the reaction rates for propagation and termination, respectively. To minimize the production of light gases, it may be preferable to have as high a as possible, defined by the actual catalyst used and the process conditions.

The H₂/CO usage ratio in the LTFT-synthesis may be in the range 2.05 to 2.2 depending on a and to some extent on the selectivity to other products but alkanes. Another important characteristic of the FT-reaction is its high exothermicity as given above. The actual enthalpy of reaction varies with the polymerization probability, the olefin to paraffin ratio, deviations from ASF distribution, methane selectivity and by-products formation. Handling the heat evolved greatly influences the reactor and process designs. For fixed-bed and slurry reactors it is convenient to remove heat and control the reaction temperature by boiling water. Analysis of the FT reactions gives a preferred range of process conditions for LTFT synthesis that may include one or more of:
Operating temperature between 210° C. and 260° C. At the high end there may be unfavorable production of light gases including methane. Further, accelerated deactivation should be considered. On the other hand, reaction rates may be high and steam produced by the reaction heat may be obtained at favorable pressure. Too low temperatures may be prohibited by low reaction rates.
Elevated reaction pressure. Process intensification dictates a reaction pressure of at least 10 bar, and most XTL processes operate in the range 25-30 bar, but even higher pressures may be used. High pressures favor high conversion rates and formation of long chained hydrocarbons.
An effective H₂/CO ratio in the feed to the FT reactor close to or slightly below two. As this is below the consumption ratio, the H₂/CO ratio is reduced further along the reaction pathway favoring synthesis of long hydrocarbon chains.

Embodiments include using syngas for the Fischer-Tropsch reaction. The syngas may be cleaned and pre-treated in a suitable manner so that the gas fed to the FT reactor(s) 3 substantially comprises CO and hydrogen. Such cleaning may include sulfur removal, e.g., in a ZnO absorber. Active carbon and/or zeolites may be used to remove other trace impurities like ammonia and metal carbonyls. Syngas may be produced by mixing hydrogen with CO₂ and shifting CO₂ to CO in the CO generation system 1, that may comprise a rWGS reactor. Due to the recycling of unconverted syngas, and optionally using a pre-reformer, the feed to the CO generation system may comprise hydrogen, CO, CO₂, steam and some methane. Between these components there is an equilibrium relation given by the stoichiometric equation:

CO+H₂O=CO₂+H₂

This reaction is called the water-gas-shift reaction, and by operating a shift reactor at certain conditions the equilibrium can be forced to the left, thereby the denotation reverse water-gas-shift (RWGS). A gas mixture may be obtained which is rich in carbon monoxide, and where the concentration of carbon dioxide is reduced. Shifting the reaction toward CO is favored by high temperature and high partial pressure of hydrogen. Excess hydrogen in the process may be required in any case because hydrogen is a key component in the final syngas. Improved reaction velocity may be provided by use of suitable catalysts. It is understood, however, that at high temperatures, above 800° C., preferably above 1000° C., a catalyst may not be needed. The shift process is nearly pressure independent and the same pressure as in other process units may be used. In a traditional “high-temperature” shift reactor, typical exit temperature is 420° C. Note that “high-temperature” here refers to a different temperature range than for a FT-reactor, and for the reverse water-gas-shift reaction much higher temperatures can be applied. A catalyst for the traditional “high-temperature” shift reactor may be based on chromium and/or iron.

From the above water-gas-shift equation, it can be seen that water in the feed is not beneficial for the RWGS reaction according to Le Chatelier's principle. However, some steam and/or CO₂ is expected to be required to suppress coking in feed lines if RWGS is carried out at temperatures above 500-600° C. Methane may also be present in the feed to the RWGS reactor, e.g. below 10 mol %. Methane is inert to the FT-reaction. Some methane may be produced by the FT-reaction. If this methane is not removed by a purge stream, it may accumulate in the system due to recycling. A purge stream may remove carbon from the system, and thereby reduce the overall product yield. It should be noted that some purge may be required, e.g. if residual nitrogen and other inert gases are to be removed. A preferred option may be to convert the methane in the RWGS-reactor itself. One option is that this reactor becomes a combined RWGS and steam methane reformer (SMR). An SMR typically employs a catalyst based on nickel as active metal on a high-temperature support material, like a spinel compound or alumina. The SMR catalyst may also work synergistically to increase the reaction rate and secure equilibrium of the RWGS reaction. The following chemical reaction takes place by steam reforming of methane:

CH₄+H₂O=CO+3H₂
in addition to the shift reaction. Accordingly, more syngas thus may be produced ready for being converted to products. The heat of reaction for steam reforming is strongly endothermic, coming in addition to the endothermicity of the RWGS reaction. However, the amount of methane may be limited. In any case, a significant temperature drop may be experienced if additional heat is not provided. It may be necessary to heat the gaseous stream(s) to the RWGS. Additional heat may be provided by suitable means, e.g. electrical resistance or inductive heating. Internal or external combustion is also a possibility. In the latter cases, oxygen produced by electrolysis of water can be used.

The above described RWGS-SMR reactor is very different from a traditional SMR reactor. In the traditional SMR reactor, methane is converted in a tube reactor at high temperature and moderate pressure. A world-scale steam reformer consists of many reactor tubes, e.g. 200-250 tubes with typical lengths of 12-13 meters, inside diameter of about 10 cm and an outside diameter of about 12 cm. This is a space demanding unit with a length of 30-50 meters, width of 10-12 meters and a height of 15-20 meters. Conventional steam reformers are operated in the pressure range from 15 to 30 bar. The outlet temperature of the gas from a conventional steam reformer lies in the temperature area of 950° C. The energy which is used to carry out the endothermic reactions is supplied by external firing/heating (top-, side-, bottom- or terrace-fired). The ratio between steam and carbon may be from 2.5 to 3.5, and the ratio between hydrogen and carbon monoxide in the product stream may be from 2.7 to 3.0.

Alternatively, the reforming of natural gas can take place in an autothermal reformer (ATR). In an ATR methane is fed together with oxygen, enriched air or air into a combustion chamber (burner). The energy which is required to operate the endothermic steam reforming reactions is provided by the exothermic reactions between methane and/or hydrogen and oxygen according to the equation

CH₄+½O₂→CO+2H₂.

The temperature in the combustion chamber can reach more than 1500° C., or more than 2000° C. After the combustion chamber the reactions are driven to equilibrium over a catalyst bed before the synthesis gas is leaving the reactor at approximately 1000-1050° C. The size of such a unit could be a height of 10-15 meters and a diameter of 5-6 meters. Typical ratio of steam: carbon is from 0.6 to 1.4. Steam is often in part mixed with the oxygen, at least when pure oxygen is used. Pure oxygen is very reactive and mixing with steam makes handling easier.

The catalyst used in ATR is most frequently comprises nickel on a high temperature stable support material. Sometimes palladium is used, e.g., in the upper part of the catalyst bed. A high temperature inert material is often used on top of the catalyst bed to protect the catalyst from imminent exposure to the hot gases from the burner, and in the lower part to secure support for the catalyst. The inert material is composed of a high temperature stable material that may comprise one or more of alumina, magnesia, magnesium oxide, silica, zirconia and titania. Specifically, the inert material can be α-alumina, a spinel compound or cordierite. The latter, 2MgO₂Al₂O₃₅SiO₂, is often used as support material in exhaust catalysts in the form of monoliths. Other suitable shapes of inert materials or catalyst supports are in the form of spheres, extrudates, tubes, and wagon wheels. Tubes are sometimes referred to as raschig rings.

A further option for reforming natural gas is a partial oxidation reactor (POX) which also is an autothermal reformer except that the unit does not comprise a catalyst bed. Conventionally, the exit gas is cooled down rapidly using a waste-heat-boiler (WHB) that produces steam. Rapid cooling and using tubes with boiling water are important to be able to control material corrosion by metal dusting. POX operates normally at high temperatures, say above 1200° C. This has the advantage that methane and other hydrocarbons are instantly partially combusted to syngas and any potential coking is avoided. A disadvantage is reduced energy efficiency. There are developments to design a lower temperature POX technology, say below 800 C.

From the above discussion of RWGS, SMR, ATR and POX it is understood that there are many options to produce syngas from natural gas, as well as to convert tail gas in a recycle stream. The CO generation system 1 can be a combined RWGS-POX reactor, that are combined or in two separate sections. Hydrogen can be added to RWGS-POX reactor, and/or directly to the RWGS section.

Optional pre-treatment of recycled gas to the RWGS reactor may comprise pre-reforming, whereby higher hydrocarbons like ethane is converted by steam to methane and CO₂. The pre-reforming may take place at a pressure within the interval 5 to 200 bar, preferably between 10 and 30 bar. The pre-reforming may take place at a temperature between 30° and 700° C. Reactions in a pre-reformer are exemplified by:

C₃H₈+2 H₂O→CO₂+2CH₄+H₂

and

CH₃OH+H₂O→CO₂+3H₂.

Both propane and methanol, as examples of hydrocarbons and oxygenates, may be transformed into gaseous molecules that already are present in the feed streams to the process, in addition to methane. The main benefit of having a pre-reformer may be that molecules prone to coking are removed from the system. It is also possible to deliberately remove and recycle additional light components from the liquid hydrocarbon product to the pre-reformer, by flashing at a desired temperature.

Certain aspects of the RWGS-reactor are described above. There is, however, a possible disadvantage when this reactor, or a combined RWGS-SMR reactor, or an RWGS-POX reactor, contains a catalyst like a catalyst comprising nickel, as nickel under certain process conditions and certain feed compositions is prone to coking. Surprisingly, using a pre-reformer might not be necessary, and an alternative way has been found to suppress coking. The reactor used is termed a syngas reactor, but still the RWGS reaction is the principal reaction that proceed. The reactions to be suppressed comprise:

CO₂→CO+C, the Boudouard reaction

CₙHₙ₊₂→, Cₙ+nH₂, coking

CH₄→C+2H₂, methane decomposition

CO+H₂→C+H₂O. CO reduction

The last reaction is a reformulation of the Boudouard reaction combined with the RWGS reaction. CO reduction is suppressed by having steam in the feed to the reactor. Such steam can be added to any of feed lines, i.e., for recycle gas, oxygen or CO₂ as long as the temperature does not exceed a critical value for the reaction to proceed. In particular, it is advantageous to add steam to the recycle gas containing CO. One possibility is to use steam generated by cooling the FT reactor(s). Another possibility is to add oxygen and possibly also hydrogen such that enough steam is produced. In case a pre-reformer is used, steam is added before this processing unit as described above.

Embodiments, however, use a carbon source that contains both CO and CO₂, and it has been found that such a carbon source can eliminate the need for a dedicated RWGS reactor, or part of a reactor; in particular an RWGS reactor treating the carbon containing gas stream 32 that is the main carbon input to the fuel generation system.

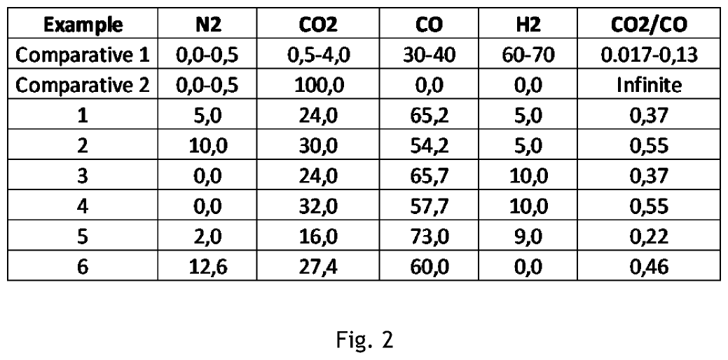

FIG. 2 comprises a table that shows the composition (mol %) of carbon sources according to the below described comparative examples and embodiment examples.

### Comparative Example 1

Comparative example 1 represents ranges for carbon sources based on reforming of natural gas. Clearly, the CO₂/CO ratio shown in the table in FIG. 2 is outside of the technology of embodiments. Further, the nitrogen content is comparatively low.

### Comparative Example 2

Comparative example 2 represents a pure, or approaching pure, carbon source that consists of essentially only CO₂. This can be CO₂ extracted from the air, totally combusted hydrocarbons removing formed water, or gas from gasification where CO₂ have been separated. Clearly, such a high CO₂ concentration does not comply with the technology of embodiments.

### Embodiment Examples 1-6

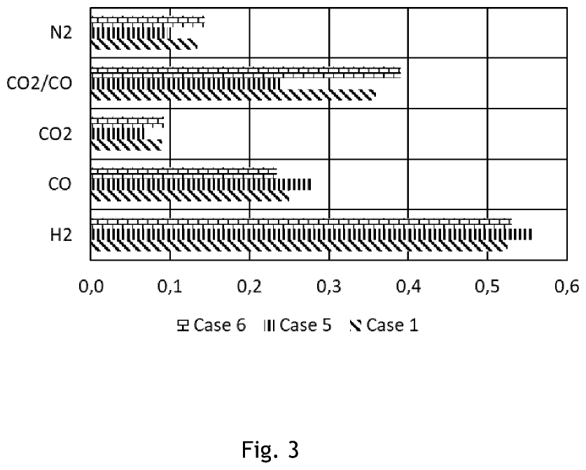

Embodiment examples 1-6 are all according to embodiments of the present invention and have the carbon source compositions as shown in the table shown in FIG. 2. In these embodiment examples 1-6, that respectively correspond to cases 1-6, the carbon sources come from electrochemical carbothermal reduction making ferromanganese. All data are according to simulations of the process shown in FIG. 1, assuming the following condition for the FT-reactor: temperature=210° C.; pressure=30 bar; H₂/CO feed ratio=2.0-2.2; CO conversion=90%; and methane selectivity 8.84 mol %. 75% of the produced hydrogen is directed directly to the FT-reactor 3, and the rest to the CO generation system 1. FIG. 3 shows the molar fractions in the feed to the FT-reactor 3 and CO₂/CO ratio. The figure shows that the feed to the Fischer-Tropsch reactor 3 contains at least 9 mol % nitrogen, total 15 mol % inerts (CO₂+N₂), and a CO₂/CO ratio below 0.5 but above 0.2.

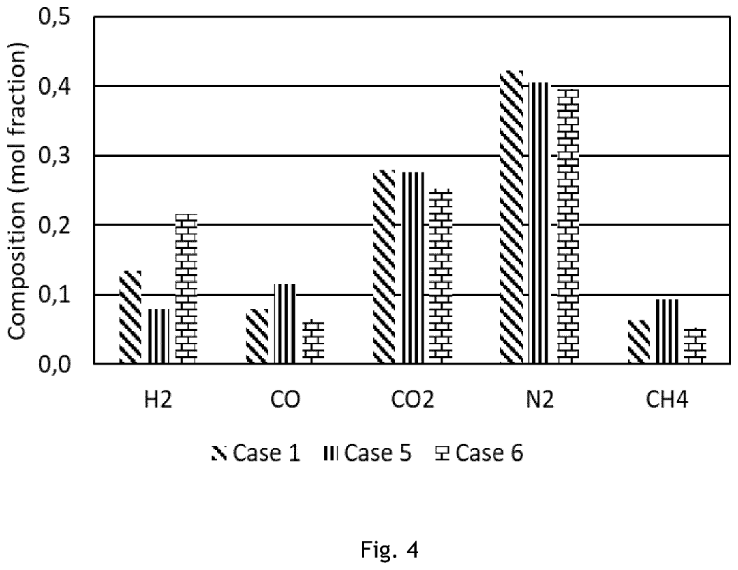

Note that a RWGS-POX reactor is used as the CO generation system 1 to essentially remove all methane and gaseous hydrocarbons from the recycled tail-gas and partially convert CO₂ to CO. The temperature out of the POX section of the reactor, i.e. the first section, is 1341° C., 1466° C. and 1391° C. for cases 1, 5 and 6, respectively. The temperature out of the RWGS section of the reactor, i.e. the second section, is 1118° C., 1127° C. and 1165° C. for cases 1, 5 and 6, respectively. FIG. 4 shows the molar fractions in dried tail-gas; excluding less than 1 mol % of ethane and higher hydrocarbons. This figure illustrates that the recycle gas, i.e., part of the tail gas, has a CO₂/CO ratio substantially higher than 1.0, even higher than 2, and it is therefore necessary to convert some CO₂ to CO, as done in the CO generation system 1. The total amount of inerts for the FT-reaction is at least 65 mol % (N₂+CH₄+CO₂) where nitrogen alone is at least 35 mol %.

### Embodiment Example 7

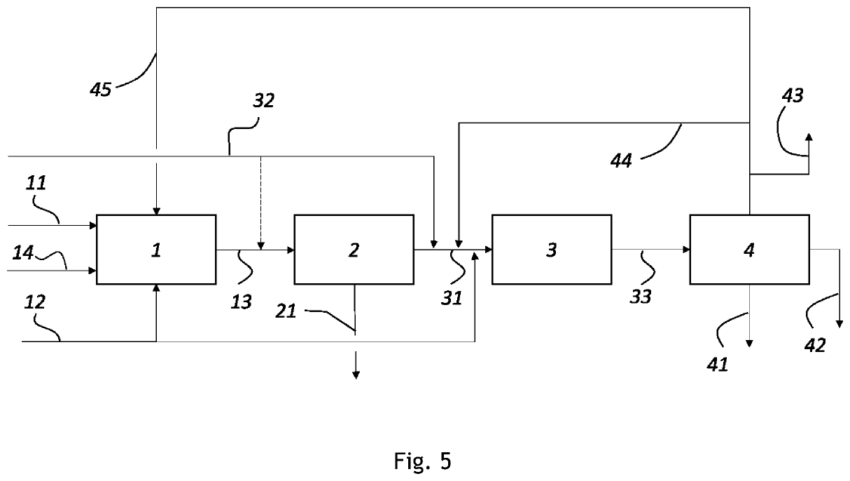

A schematic block diagram of embodiment example 7 is shown in FIG. 5. In FIG. 5, all of the fluid streams 11, 12, 13, 21, 31, 32, 33, 41, 42, 43, 44 and 45, and process units 1, 2, 3 and 4, are as described earlier with reference to FIG. 1. The embodiment example 7 differs from the earlier described embodiments by further comprising a conduit for supporting fluid stream 14.

Fluid stream 14 may add other organic sources to the CO generation system 1. Such other organic sources may be biomass or pretreated biomass. The biomass may be any sort of waste products, e.g., forestry wastes or crop residues; or dedicated grown biomass. Pretreated biomass comprises torrefaction, pyrolysis and gasification and fermentation. Other, at least partly, organic sources are municipal waste; and fossil coal, oil and/or gas. These other organic sources can also be pretreated in some way like in off-gases from an industrial plant, refinery etc. The added product in fluid stream 14 may also be CO₂ from any source. In this embodiment, the carbon source for generating fuel is contained both in streams 32 and 14.

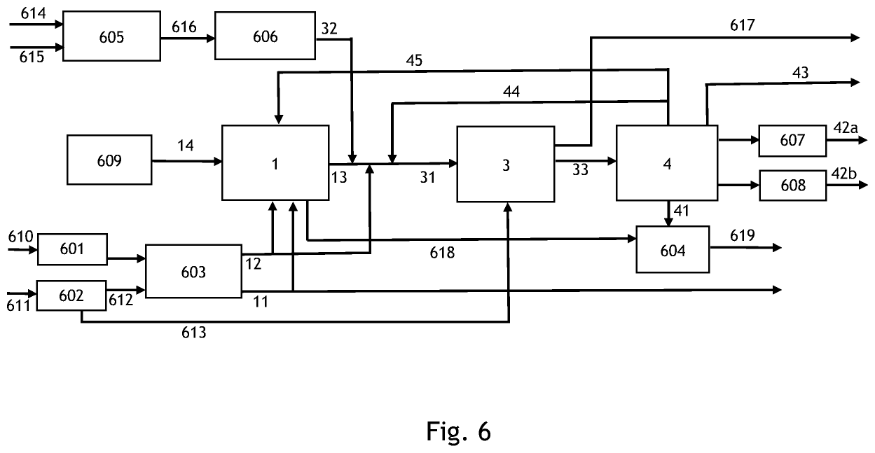

FIG. 6 is another schematic block diagram of at least some of the components of a fuel generation system according to an embodiment. In FIG. 6, all of the fluid streams 11, 12, 13, 14, 31, 32, 33, 41, 42, 43 and 44 are as described earlier with reference to FIGS. 1 and 5. In FIG. 6, all of the process units 1, 3 and 4 are as described earlier with reference to FIGS. 1 and 5. The embodiment in FIG. 6 may further comprise a cleaning section 2, as described earlier with reference to FIGS. 1 and 5, however this is not shown in FIG. 6.

### Embodiment Example 8

FIG. 6 shows some of the further apparatuses and systems that may be present for generating the feeds that are the input products to the earlier described fuel generation systems according to embodiments. FIG. 6 also shows some of the further apparatuses and systems that may be present for supporting the output flows of fluids from the earlier described fuel generation systems according to embodiments.

The system component 605 may be a Fe/Mn/Si Reduction Furnace. The input 614 to system component 605 may be electrical power. The input 615 to system component 605 may be bio-carbon. The gas stream 616 may be furnace gas and the main carbon source of the fuel generation system. The system component 606 may be arranged to cool, compress and/or buffer the furnace gas in gas stream 616.

The system component 609 may be another carbon source, such as biogas or CO₂.

The system input 610 may be electrical power. This may be rectified in system component 601 and then input into system component 603. The system input 611 may be water. The system component 602 may be a water purification system. Fluid stream 612 may be a stream of substantially pure water that is input to system component 603. System component 603 may be a system that is arranged to perform alkaline electrolysis of the received water in stream 612. The fluid stream 12 may be hydrogen that is generated by the electrolysis performed in system component 603. The fluid stream 11 may be oxygen that is generated by the electrolysis performed in system component 603. Fluid stream 613 may be a stream of substantially pure water that is input to cooling of the FT reactor 3.

Fluid stream 617 may be a flow of steam out of the cooling system of the FT reactor 3.

Fluid stream 618 may be a flow of water out of the CO generation system 1 and/or the cleaning section 2 (not shown in FIG. 6). The system component 604 may be arranged to clean the water that it receives through inputs 618 and 41. The fluid stream 619 may be a flow of cleaned water out of the fuel generation system.

The fluid stream 42a may be a flow of medium Fischer-Tropsch liquid (MFTL) and a main output of the fuel generation system. The system component 607 may be arranged to store, meter and/or process the flow of medium Fischer-Tropsch liquid.

The fluid stream 42b may be a flow of heavy Fischer-Tropsch liquid (HFTL) and a main output of the fuel generation system. The system component 608 may be arranged to store, meter and/or process the flow of heavy Fischer-Tropsch liquid.

The CO generation system 1, that may comprise a POX (partial oxidation) reactor, may be a syngas production system. The CO generation system 1 may comprise: a POX burner, a POX reactor, a syngas cooler and heat recuperator, and a syngas cleaning system.

The purge gas in stream 43 may be burned in a fired heater. The fired heater may be part of the syngas production system in the CO generation system 1. The fired heater may supply heat to the CO generation system 1.

The system according to embodiments may use renewable electricity in the generation of liquid hydrocarbons, MFTL and HFTL, and these can directly replace fuels based on fossil oil and gas. These new fuels are called electro-fuels, or e-fuels, and can for example be SAF (sustainable aviation fuels).

Embodiments improve on known techniques by:
Using a Carbon source in the form a gas that contains appreciable amounts of both CO and CO₂.
The received CO₂/CO mixture has hydrogen added and may then be fed directly to the FT reactor 3.
The CO₂ together with methane and other hydrocarbon gases and some unreacted hydrogen and CO is sent to a CO generation system 1. The CO generation system 1 may be conventional and commercially available.
The CO generation system 1 may convert hydrocarbon gases produced in the FT reactor 3 and most of the CO₂ from the carbon source(s) (e.g. via the FT reactor 3) to syngas. This is achieved by the following functionalities/characteristics:
Partial oxidation of the hydrocarbon gases using oxygen from the water electrolysis
rWGS of the CO₂ using unreacted hydrogen from the FT reactor 3 and some hydrogen from the electrolysis. The amount of hydrogen addition is low enough that the operating conditions are kept inside a well-known operating envelope in industrial scale operation of the CO generation system 1 while still satisfying the criteria needed to achieve rWGS-conversion of the CO₂.
Substantially no/negligible soot/coke formation and substantially no problem with metal dusting.
Substantially no need for pre-reforming of hydrocarbon gases from the FT-reactor (to avoid soot/coke formation and avoid problem with metal dusting)
Substantially no need for additional steam injection (to avoid soot/coke formation and avoid problems with metal dusting).
Substantially no need for catalysts, due to high gas outlet temperature (>1400° C.) from the POX section of the CO generation system 1.
Very high conversion of CO₂ due to the high temperature.
Short retention time needed due to the high temperature
The high temperature is achieved by the partial oxidation of the hydrocarbon gases.

If the amount of hydrocarbon gases from the FT reactor 3 are too small to reach the high temperatures, additional combustible material may be used. This may be an additional carbon source, such as biogas, shown by the input stream 14 in FIGS. 5 and 6.

The fuel generation system according to embodiments may utilize several different sources of carbon in the same plant, for example, but not limited to:
Blast furnace gas from a ferro manganese plant
Blast furnace gas from a ferro silicon plant
CO₂ captured from the air or any industrial source

Such gases will normally also contain significant and rapidly varying amounts of Nitrogen (N₂). The ratio between CO₂ and CO may also vary substantially and rapidly (e.g. during minutes). High inert gas content and large and rapid changes in gas composition (CO/CO₂ and N₂) is a challenge for known systems. However, the CO generation system 1 and the FT reactor 3 according to embodiments are advantageously able to operate despite substantial and rapid variations in CO, CO₂ and N₂ concentrations.

Embodiments include a number of modifications and variations to the above-described techniques.

In particular, the CO generation system 1 may be the reactor 1 as disclosed in WO2021/185869 A1, the entire contents of which are incorporated herein by reference. CO generation system 1 may be a reactor system that comprises a plurality of reactors. One or more of the reactors may be the reactor 1 as disclosed in WO2021/185869 A1.

CO generation system 1 may comprise either a catalytic or non-catalytic partial oxidation reformer.

Embodiments include using one or more heat exchangers, compressors, pumps, coolers, heaters, cleaning sections, water removal sections and/or other components in the fuel generation system that may be in addition to the components shown in FIGS. 1, 5 and 6.

Embodiments include to following numbered clauses:
1. A process for producing hydrocarbons by the Fischer-Tropsch process comprising:
   utilizing a carbon source containing a molar CO₂/CO ratio of at least 0.10.
   the carbon source containing a molar CO₂/CO ratio below 2.0.
   the carbon source containing at least 3 mol % H₂.
   the Fischer-Tropsch process employing a supported cobalt catalyst.
   the Fischer-Tropsch tail-gas containing at least a molar CO₂/CO ratio of 1.0
   at least 30% of the Fischer-Tropsch tail-gas is recycled to a reformer.
2. The process of clause 1 wherein off-gas from production of iron or ferroalloys is used as carbon source.
3. The process of clause 2 wherein off-gas from production of ferromanganese is used as carbon source.
4. The process of clause 1 wherein gas from reforming natural gas is used as carbon source.
5. The process of clause 4 wherein the reforming is conducted at a temperature below 800° C., preferably below 700° C., more preferably below 600° C.
6. The process of clause 4 wherein catalytic partial oxidation is used as reformer.
7. The process of clause 6 wherein the catalyst comprises at least one noble metal.
8. The process of clause 1 wherein gas from gasification of biomass is used as carbon source.
9. The process of any proceeding clause wherein hydrogen is added to the process from electrolysis of water.
10. The process of clause 1 wherein the reformer is a non-catalytic POX (partial oxidation) reactor.
11. The process of clause 1 wherein the carbon source contains at least 1.0 mol % N₂, preferably at least 3 mol %, more preferably at least 10 mol %.
12. The process of clause 11 wherein the feed to the Fischer-Tropsch reactor contains at least 3 mol % nitrogen, preferably at least 8 mol %, more preferably at least 12 mol %.
13. The process of any proceeding clause wherein at least 80% of the carbon in the carbon source is converted to liquid hydrocarbons, preferably more than 85, more preferably more than 90%.
14. The process of any proceeding clause wherein the carbon source contains a molar CO₂/CO ratio of at least 0.15, preferably at least 0.20, more preferably at least 0.25.
15. The process of any proceeding clause wherein the carbon source contains a molar CO₂/CO ratio below 1.5, preferably below 1.0, more preferably below 0.5.
16. The process of any proceeding clauses wherein the tail-gas contains a molar CO₂/CO ratio of at least 1.5, preferably at least 2.0, more preferably at least 2.5.
17. The process of any proceeding clauses wherein the POX reactor, in addition to part of the tail-gas, is fed by an alternative carbon source like in biomass or pretreated biomass; off-gases from an industrial plant; municipal waste; or any other hydrocarbon source.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1-24. (canceled)

25. An arrangement comprising a carbon generator and fuel generation system wherein:
the carbon generator is a metal reduction furnace that is arranged to generate a first gas stream, that is a carbon source, and to supply the first gas stream to the fuel generation system; and
the fuel generation system is arranged to generate fuel in dependence on the first gas stream;
wherein the fuel generation system comprises:
a Fischer-Tropsch (FT) reactor system arranged to generate and output the fuel and a tail gas;
a CO generation system arranged to receive at least some of the tail gas, and to generate, in dependence on the received tail gas, a second gas stream that comprises CO; and
one or more supply conduits arranged to supply H2 and carbon to the FT reactor system, wherein the carbon is sourced from both the first gas stream and the second gas stream such that at least some of the carbon received by the FT reactor system has not been output from the CO generation system;
wherein:
the input gasses to the FT reactor system comprise both CO and CO2 with a molar CO2/CO ratio that is at least 0.10;
the supply of CO and H2 in the input gasses to the FT reactor system are a supply of syngas; and
the FT reactor system is arranged to generate the fuel in dependence on the received syngas.

26. The arrangement according to claim 25, wherein the carbon generator is an iron production plant, a ferro alloy production plant, a ferro manganese production plant and/or a ferro silicon production plant.

27. The arrangement according to claim 25, wherein the fuel generation system further comprises:
a separation system arranged to receive output products from the FT reactor and to separate them into at least one or more liquid fuels and the tail gas;
wherein the tail gas comprises syngas, CO₂ and gaseous hydrocarbons;
wherein the first gas stream is input into the separation system.

28. The arrangement according to claim 25, wherein the fuel generation system further comprises:
a supply conduit arranged to supply O2 to the CO generation system;
a supply conduit arranged to supply H2 to the CO generation system;
a supply conduit arranged to supply at least some of the tail gas to the CO generation system; and
an output conduit from the CO generation system arranged to supply output products from the CO generation system to the FT reactor system;
wherein:
the output products from the CO generation system include syngas that has been generated in dependence on at least the received tail gas.

29. The arrangement according to claim 25, wherein the fuel generation system further comprises a cleaning section arranged in a fluid flow path between the CO generation system and the FT reactor system;
wherein the cleaning section is arranged to remove water from the output products from the CO generation system.

30. The arrangement according to claim 25, wherein the fuel generation system further comprises a supply conduit arranged to supply at least some of the tail gas to the FT reactor system in a gas recycle loop that does not pass through the CO generation system.

31. The arrangement according to claim 25, wherein the fuel generation system further comprises a supply of a further carbon source to the CO generation system; and
wherein the further carbon source comprises one or more of CO₂, biomass, municipal waste, fossil coal, oil, or gas.

32. The arrangement according to claim 25, wherein the fuel generation system further comprises an output conduit for outputting some of the tail gas as a purge gas; and
a burner arranged to receive and burn at least some of the purge gas to thereby generate heat for use in the fuel generation system.

33. The arrangement according to claim 25, wherein the CO generation system comprises a partial oxidation (POX) reactor and/or a reformer.

34. The arrangement according to claim 25, wherein said input gasses to the FT reactor system have a molar CO2/CO ratio that is at least 0.10, a molar CO2/CO ratio that is greater than or equal to about 0.15, and is preferably greater than or equal to 0.20, and is more preferably greater than or equal to 0.25; and
wherein the first gas stream has a molar CO2/CO ratio that is less than or equal to about 2.0, and is preferably less than or equal to about 1.5, and is more preferably less than or equal to 1.0, and is more preferably less than or equal to about 0.5.

35. The arrangement according to claim 25, wherein at least 30% of the tail gas is supplied to the CO generation system.

36. The arrangement according to claim 25, wherein the CO generation system is arranged to operate at a temperature above 1000° C., preferably above 1100° C., more preferably above 1200° C., and more preferably above 1400° C.

37. The arrangement according to claim 25, wherein the tail gas comprises a molar CO2/CO ratio of 1.

38. The arrangement according to claim 25, wherein the input gasses to the FT reactor system comprise at least 3 mol % H2.

39. The arrangement according to claim 25, wherein the first gas stream comprises at least 1.0 mol % N2, preferably at least 3 mol %, more preferably at least 10 mol %.

40. The arrangement according to claim 25, wherein input gasses to the FT reactor system comprise at least 3 mol % N2, preferably at least 8 mol % N2, more preferably at least 12 mol % N2.

41. The arrangement according to claim 25, wherein the tail-gas comprises a molar CO2/CO ratio of at least 1.5, preferably at least 2.0, more preferably at least 2.5

42. The arrangement according to claim 25, wherein the first gas stream is directly input into the FT reactor system.

43. The arrangement according to claim 25, further comprising an electrolysis system that is arranged to generate H2 and O2 and to supply at least some of the H2 and O2 to the fuel generation system.

44. A method of generating fuel, the method comprising:
generating a carbonaceous gas by a carbon generator;
supplying the carbonaceous gas to a fuel generation system; and
using the fuel generation system to generate fuel in dependence on the received carbonaceous gas,
wherein the carbon generator and the fuel generation system are in the arrangement according to claim 25.
